(19) United States
(12) Patent Application Publication
(10) Pub. No.: US 2008/0291774 A1
(43) Pub. Date: Nov. 27, 2008

(54) System of devices for the production of a ready-to-use filler by mixing together a binder and hardener component

(75) Inventor: Klaus-W. Voss, Uetersen (DE)

Correspondence Address: Friedrich Kueffner, Suite 910, 317 Madison Avenue, New York, NY, 10017, US

(73) Assignee: VOSSCHEMIE GmbH

(21) Appl. No.: 11/900,647

(22) Filed: Sep. 12, 2007

(30) Foreign Application Priority Data
Sep. 12, 2006 (DE) 20 2006 014 187.1
Nov. 13, 2006 (EP) 06 023 546.2
Feb. 23, 2007 (EP) 07 003 740.3
Mar. 29, 2007 (DE) 20 2007 004 570.0
May 10, 2007 (EP) 07 009 374.5
May 31, 2007 (DE) 20 2006 007 782.3

(51) Int. Cl. B01F 15/02

(52) U.S. Cl. 366/151.2

(57) ABSTRACT

A device system for mixing together two components, to form a pasty or fluid mixed product for the production of a ready-to-use filler for the priming of surfaces of vehicle bodies includes a support plate arranged in a device assembly, with an inlet opening for feeding the binder component, and with at least one further inlet opening for feeding the hardener component from a storage container, and with outlet openings connected to the inlet openings, and a mixing device that can be connected functionally to the support plate. A number of inlet openings of the mixing device corresponds to the outlet openings), the mixing device has a hollow cylindrical stator part with a discharge opening for the mixed product, and a rotor part arranged concentrically in the stator part and rotatably about a longitudinal axis.

This Invention Relates to a System of Devices for the production of a ready-to-use filler by mixing together at least two components, in particular a binder component and a hardener component, to form a pasty or liquid mixed product.

Such devices for mixing at least two components are used, for example, in the production of fillers, where a hardener component is added in a proportion of 1-2% to a binder component to produce a settable filler. For feeding the components concerned, the mixing device has inlet openings through which the components are fed into the mixing chamber. The components are stored in downstream connected receiving containers, such as cartridges or the like, the mixing device forming part of a device for supplying fillers.

Such a device for the production of a ready-to-use filler for the priming of surfaces relating, for example, to vehicle bodies, is disclosed in DE 203 07 518 U1. The device has two storage containers arranged on a base station, one of which is filled with a binder component, namely a filler component, and the other of which is filled with a hardener component. Both components are fed continuously, by means of a device, through a feed duct to a mixing chamber in which the components are brought into contact with each other. The mixing chamber is formed from a hose section of a flexible hose, on which engage, on the outside, press rolls which compress the hose section and at the same time drive it as it rotates about a longitudinal axis. The components are mixed together by the friction generated here, and the adhesion of the components to the inner wall of the hose. After the mixed product has passed through the hose section is fed to an outlet opening provided on the hose, at which outlet it escapes continuously from the hose. The hose wall consists of an airtight plastic, so that the air surrounding the hose does not reach the mixed product during the mixing process and can be enclosed in it in the form of pores or bubbles.

EP 1 627 690 A discloses an adhesive gun for the application, in particular, of a two-component adhesive which in a simple manner allows a wide range of mixing ratios between a relatively viscous adhesive component and a relatively fluid adhesive component in an adhesive gun. This adhesive gun comprises a first cylindrical container which is provided with a first piston for squeezing a relatively viscous adhesive component from a first cylindrical container, a second cylindrical container which is provided with a second piston for squeezing a relatively fluid adhesive component from the second cylindrical container, a mixing unit into which open the first and second cylindrical containers, and driving means for moving the first and second pistons, where the working means are deigned for a greater speed of the first piston than the speed of the second piston, and where the first cylindrical container has a greater inside diameter than the second cylindrical container.

EP 1 570 805 A discloses a device for producing a mixture of a plurality of components, in particular for dental purposes: this device comprises at least two cartridges, each cartridge containing one component of the mixture of a plurality of components and a piston which is designed for squeezing the component from the cartridge and a working device for the pistons, in which the driving speed can be adjusted, the driving device having a step motor. At low speeds per minute the step motor will provide a higher torque compared to d.c. motors of prior art, whilst it also makes available high speeds per minute, albeit with a comparatively low torque, which is sufficient for rapid feed and return of the pistons.

U.S. Pat. No. 6,499,630 B discloses a device for the proportional ejection of two or more flowable substances from two or more syringes, at least one of which is also used alone or in combination with other syringes, particularly for dental purposes. According to this arrangement provision is made for both the syringe body and the syringe piston to be coupled rigidly together by detachable coupling devices independently of the corresponding piston position in the feed direction, so that the pistons and/or the syringe bodies can be connected together in the feed direction in any relative position. This arrangement also provides that the syringe bodies can be coupled together in only one predetermined relative position, whilst the piston rods associated with the pistons can be coupled together in only one relative position.

In practice, however, it has been shown that the filler mixed with the device still occasionally displays inhomogeneities. When the filler is applied to the surface of a vehicle body, the filler does not set sufficiently at the points where no hardener component is present. It is relatively expensive to remove such defects because the filler has to be removed from the body by sanding and the body then has to be refilled. If such defects remain undetected during a repair, and the body is then painted, it will even be necessary to repaint the area in question. If the mixing device remains out of use for a long time, the filler may dry out, particularly in the end region of the hose, resulting in the device becoming unusable. In addition, the hose is subjected to considerable wear because a great deal of energy is consumed in the hose when the device is operating. Furthermore, the device is very expensive and takes up considerable space because of the press rolls.

A further disadvantage can be seen in the fact that the addition of the hardener component is not possible, at least by means of a visual inspection, so that continuous feeding of the hardener component into the binder component is not guaranteed. Any portions of compound of the binder component which are not mixed with the hardener component cannot be identified, so that it is uncertain whether or not there are air bubbles in the hardener component by simply feeding the hardener component through an internal feed tube.

The object of the invention is therefore to provide a system of devices for homogeneous mixing of at least two components for producing a ready-to-use fully settable filler without air inclusions using two functionally interacting system components, namely a mixing device and a raw substance feeding device.

The achievement of this object is described in Claim 1.

Advantageous designs are described in the dependent claims.

The system of devices according to the invention for mixing together at least two components, in particular a binder component A and a hardener component B, to form a pasty or fluid mixed product for the production of a ready-to-use filler for the priming of surfaces, for example those of vehicle bodies, comprises a support plate with an inlet opening for feeding binder component A from a storage container arranged on the support plate, with at least one further inlet opening for feeding hardener component B from a storage container arranged on the support plate and with outlet openings connected to the inlet openings via feed ducts in the support plate, and a mixing device that can be connected functionally to the support plate with a number of inlet openings of the mixing device corresponding to the number of outlet openings in the support plate, the inlet openings corresponding to the outlet openings. The mixing device has a hollow cylindrical stator part with a discharge opening formed in its wall for the mixed product, and a rotor part arranged concentrically in the stator part that can be rotated about a longitudinal axis, with a mixing chamber designed in the manner of an annular gap between the stator part and the rotor part, where a plurality of first mixing teeth formed on the stator part extend radially inwards and a plurality of second mixing teeth formed on the rotor part extend radially outwards into the mixing chamber in order to move the mixing teeth towards each other by means of a rotary movement of the rotor part in the stator part so that components A and B are mixed together. Here the stator part has at least one, preferably two inlet openings connected to the mixing chamber for hardener component B, and the first mixing teeth are arranged in at least one first mixing tooth plane and the second mixing teeth are arranged in at least one second mixing tooth plane, the mixing tooth planes being displaced axially towards each other in stages in the direction of the longitudinal axis so that the second mixing teeth of the rotor part rotate radially in the corresponding intervening spaces of the first mixing teeth, where a plurality of mixing tooth planes is provided on the rotor part and/or on the stator part, where the number of mixing tooth planes on the rotor part and on the stator part is preferably the same, where the stator is provided with an annular support on its end facing away from the inlet openings for the functional connection between the mixing device and the support plate, which support has fastening openings and which is connected releasably, lockably and rotatably to the stator part in the manner of a bayonet, where the rotatability is limited by means of stops in such a manner that fitting the inlet opening for binder component A in the mixing device, with the corresponding outlet opening in the support plate, and at the same time fitting of the inlet openings for hardener component B in the mixing device, with the corresponding outlet openings in the support plate, are achieved.

The invention embodies the technical theory that the mixing device has a hollow cylindrical stator part and a rotor part received in it so that is able to rotate concentrically about a longitudinal axis, and that the mixing chamber is formed between the stator part and the rotor part in the nature of an annular gap, where a plurality of first mixing teeth formed on the rotor part extend radially inwards and a plurality of second mixing teeth formed on the rotor part extend radially outwards into the mixing chamber in order to move the mixing teeth towards each other by means of a rotary movement of the rotor part in the stator part and providing mixing of the two components, and where the stator part has at least one, preferably two inlet openings connected to the mixing chamber for the hardener component.

The binder component and the hardener component are fed by means of a control device to the mixing chamber, preferably in such a manner that a quantity of 0.1 gram to 0.5 gram, preferably 0.2 gram of pasty or fluid hardener component is injected into the mixing chamber before the beginning of each mixing process, before the feed of the binder component, and before the beginning of the continuous mixing process with the rotary movement of the mixing teeth of the mixer running in the opposite direction, whereupon the binder component and the hardener component are fed in.

The mixing device consists as a unit of two elements, namely the stator part and the rotor part. The binder component and the hardener component are fed into the mixing device via the corresponding inlet openings and directly into the mixing chamber. Because of the rotary movement of the rotor part in the stationary stator part the second mixing teeth rotate whilst the first mixing teeth are at rest. This introduces a shear or pitch into the mixed product so that the hardener component is reliably mixed with the binder component. The first mixing teeth have at least one first mixing tooth plane and the second mixing teeth have at least one second mixing plane. The mixing tooth planes are axially offset in states relative to each other in the direction of the longitudinal axis so that the second mixing teeth of the rotor part rotate radially in the corresponding intervening spaces of the first mixing teeth of the stator part. A total of at least fix mixing tooth planes can be provided from the first mixing teeth of the stator part so that the second mixing teeth of the rotor part are arranged in the corresponding intervening spaces in a total of six mixing tooth planes. In this case the mixed product runs from the inlet opening to the discharge opening through the total of six mixing tooth planes of the first mixing teeth and the six mixing tooth planes of the second mixing teeth. This considerably augments the pitch action and achieves better mixing of the components.

Advantageously, the discharge opening is designed as a radial outlet on a lateral wall section of the stator part, wherein the discharge opening is preferably circular in design and/or is arranged pointing laterally on the surface area of the stator part so that it is laterally and radially offset relative to the perpendicular. In this way, a more defined discharge of the mixed product is reached.

The mixed product is again discharged from the mixing chamber of the mixing device via the discharge opening, the discharge opening being arranged on the far side of the inlet openings so that the mixed product circulates throughout the annular gap type mixing chamber. The flow movement of the mixed product is generated by pressurisation of the respective storage containers for the components so that the components are forced through the respective inlet openings and into the mixing chamber. The mixing ratio is determined on the basis of the pressure and flow cross-section of the fed components. The binder component and hardener component are fed to the mixing chamber by means of a control device, but this has one further task.

The size of the discharge opening is preferably defined here so that 100 g of a ready-to-use filler are essentially discharged in 10 s. In particular preference the diameter of a circular discharge opening is 10 mm, which allows better mixing of the components.

Before the start of each mixing process a quantity of 0.1 gram to 0.5 gram, preferably 0.2 gram of pasty or fluid hardener component is injected into the mixing chamber before feeding of the binder component and the start of the continuous mixing process with the rotary movement of the mixing teeth of the mixer running against each other, whereupon the binder component and hardener component are supplied.

This injection of a minimum quantity of hardener component is also initiated and monitored by the control device. Incorrect mixing results are avoided by the injection of a small quantity of pasty or fluid hardener component before or at the beginning of each continuous mixing process into the mixing chamber of the device, for without this prior injection incorrect mixing results will always be obtained. It is important that the mixing ratio be up to 2% binder component to 98% hardener component. The initial volume, which is approx. 1 cm³, then receives either no hardener at all or such a highly reduced quantity of hardener that defective setting may partially be observed. A useful hardening result is therefore obtained with a benzoyl peroxide proportion (50% paste) of between 0.8% and 5%. If this volumetric proportion is not adhered to in over- or under-dosing, quality problems arise in the mixed product. Under-dosing results in an adequate final hardness. Over-dosing results in undesirable enrichment of the binder component (filler) with a softener contained in the hardener paste in a proportion of approximately 50%. If these specified values are not adhered to in the setting of the end product, incorrect end results will be obtained during painting. For this reason the solution according to the invention in Claim 1 is particularly advantageous, since useful hardening results are obtained.

This preliminary process of injecting a small quantity of hardener component before the start of the actual feeding of binder component and hardener component for the mixing process is not one that ensures the yield of binder component and hardener component in equal proportions, for the hardener component must not amount to more than 4%, otherwise impermissible reactions will occur and a peroxide bleaching action on the dye pigments contained in the hardener component may also occur, among other things.

An advantageous embodiment of this invention provides that the inlet openings open directly into the mixing chamber of the mixer, the inlet opening for feeding the hardener component being provided in duplicate to ensure redundant supply of the mixing product with the hardener component. The requirement for a redundant supply of the hardener component is based on the knowledge that inhomogeneities in the mixed product are normally caused by air inclusions in the hardener component, inhomogeneities which cannot reliably be avoided in practice even with careful production of the hardener component. Since the proportion of hardener component of the total volume of mixed product is less than 5%, and preferably only approximately 2%, even the smallest air inclusions in the hardener component may result in their being certain parts of the mixed product that contain no hardener component and hence do not set. Since preferably two storage containers are provided for the hardener component in the device according to the invention, and are connected to the mixing chamber by separate feed ducts, the hardener component can still be fed to the mixing chamber via the second feed duct if an air bubble is contained in one of the feed ducts. The risk that air bubbles of the hardener component may simultaneously be contained in all the feed ducts is reduced by a multiple and may therefore be ignored. For example, the device may be used for the following binding agent systems: polyester resins (unsaturated), peroxide-styrol systems, epoxy resins (two-component), polyurethane resin systems (two-component), phenol resin systems, silicone systems (two-component), acrylate systems (two-component) or thiocoll systems (polydisulphide systems).

In order to be able to control the feed of the hardener component by means of a visual inspection, provision is made for at least the stator part to be formed from a transparent material formed from the group of plastics comprising a polycarbonate (PC), a polymethyl metacrylate (PMMA) and/or a styrol-acryl-nitrile (SAN) or PP in random quality, preferably transparent. Here it is also of particular advantage to dye the hardener component. Because of the transparent stator part the feed of the hardener component is visible, so that the operator is able to monitor visually the feed of the hardener component during the operation of the mixing device.

The rotor part is advantageously formed from polyoxymethylene (POM), also called polyacetal or polyformaldehyde. This material has better sliding properties with a polycarbonate or polypropylene (PP).

The mixing teeth each advantageously have end faces which face towards each other in the axial direction so that the teeth can be positioned opposite each other between the stator part and the rotor part under an axially acting force. Furthermore, the end faces are inclined at an angle α to a plane arranged perpendicularly to the axis of rotation, so that during the mixing process the end faces slide onto one another without removing material from the mixing teeth that may fall into the mixed product. This enables the length of the rotor part in the direction of the rotation axis to be kept short so that after use of the rotor part or stator part, only a corresponding residual quantity of the mixed product remains in the mixing chamber. The device therefore allows a low consumption of the components. During the mixing process the mixing teeth of the rotor part and the mixing teeth of the stator part are forced against each other by the feed pressure of the components, the end faces running obliquely towards each other sliding onto each other without material being removed abrasively from the teeth and falling into the mixed product. Here the components of the mixed product form between the end faces sliding onto each other a thin film which acts as a sliding layer. Angle α, at which the mixing teeth are inclined against each other relative to the plane arranged perpendicularly to the axis of rotation, may be at least 5°, if necessary 10° and preferably at least 15°.

A further advantageous embodiment of the invention provides that the stator part comprises a support bearing surface against which bears the rotor part with mixing teeth formed on it on the end face, and onto which it slides to provide an axial sliding bearing arrangement. The rotor part is first introduced into the stator part via an open end side facing away from the inlet openings until it abuts against the supporting bearing surface with the mixing teeth. This allows the rotor part to be mounted in the stator part unilaterally and axially. The geometry of the rotor part is adapted so that the second mixing teeth of the rotor part lie in the respective intervening spaces of the first mixing teeth of the stator part when the mixing teeth abut on the end face against the support bearing surface. The axial support of the rotor part takes place in the direction of joining of the rotor part in the stator part against the support bearing surface, but here there is a risk that the first and second mixing teeth may touch each other in an axial clearance in the direction of the opening of the stator part. Because of the end faces which are arranged at an angle α, the rotor part is guided back against the support bearing surface in the joining direction from which the rotor part is pushed into the stator part.

The rotor part advantageously has end face projections which project into the inlet opening for feeding the binder component, and rotate with the rotor part in order to reduce the thixotropy of the binder component even in the feed duct of the inlet opening. When the binder component is fed into the mixing chamber the thixotropy of the binder component is temporarily and reversibly disturbed, enabling the hardener component to be distributed more efficiently in the binder component, particularly if an air bubble is present in one of the feed ducts for the hardener component, allowing only a correspondingly reduced quantity of the hardener component to be fed to the mixing chamber.

In the case of a polyester binder component, for example, the distance between the hardener component and the binder component in the mixed product must be much shorter than 0.5 mm to ensure uniform setting of the mixed product and that no areas in which no setting takes place remain in the mixed product. The projections are formed on the rotor part in such a manner that they rotate at least partially inside the inlet opening for the binder component and introduce the kinetic energy into it.

Flowability, particularly at low temperatures, which may be far below 12°, depending on the place of use, is reduced by the introduction of the kinetic energy, so that the feed pressure provided is still sufficient to introduce the binder component by means of the device for reducing the thixotropy. The thixotropy of the binder component is reversibly weakened, or even totally eliminated, by introducing the kinetic energy.

A further embodiment of the invention provides that the rotor part has on the end face an open, hollow cylindrical recess into which can be inserted, adapted to the geometry, a core by means of which the rotor part can be driven. The rotor part has a cavity which is open on one side. The core may be inserted through the hollow cylindrical opening or recess so that the rotor part can be driven by means of a rotary movement. Here the core may, for example, be connected to a motor for introducing the rotary movement into the rotor part. For torque transmission provision is made for the recess to be provided with stop ribs running radially inwards from the body of the rotor part, which ribs engage in corresponding recesses provided in the core. Eight stop ribs may preferably be provided, but a different number of stop ribs may be sufficient or required. Alternatively to the stop ribs provided, the required drive torque may also be transmitted to the rotor part by a polygon which may be designed, for example, in the nature of a hexagon-socket head system.

The rotor part advantageously has sealing lips for sealing the mixing chamber between the rotor part and the stator part and preventing the mixed product from escaping. The sealing lips are provided as rotating projections on the end face of the rotor part, and lie adjacent to the inner wall of the stator part with a clearance or transition to provide a seal for the mixing chamber. Here a plurality of sealing lips may be provided to improve the sealing action. In the region of the mixing chamber the rotor part has a first outside diameter which at the same time forms the inner wall of the mixing chamber. A second diameter begins with the arrangement of the sealing lips, it being greater than the first diameter in the region of the mixing chamber. The discharge opening in the stator part is arranged at the height of the mixing chamber so that the mixed product is able to escape from the mixing chamber in the end region of the smaller first diameter. The sealing lips are not arranged until the diameter is widened, thereby reducing the escape of the mixed product through the sealing lips on the enlarged diameter.

A further embodiment of the invention provides that the stator part has at least one plate-shaped formation on the outer circumference, with at least one of the plate-shaped formations having a half-moon-shaped stop contour in which a pin element engages when the mixing device is inserted to ensure the radial position of the discharge opening in the stator part. The discharge opening is preferably in a vertical downwardly directed position so that the operator is able to receive the ready-to-use mixed product in a container. The pin element can be arranged on a support or receiving device for the mixing device so that the mixing device, which initially consists of the rotor part joined in the stator part, is pushed onto the core, which is also arranged on the receiving unit. The pin element therefore prevents the stator part from twisting in order to guarantee that the discharge opening for the mixed product remains in the vertical downwardly directed position.

The plate-shaped formations act as stabilising collars which at the same time may serve a grip for the operator to receive the mixing device. This is to prevent soiling of the hands of the operator when changing the mixer. The half-moon-shaped recess may alternatively be designed drilled hole, so that the pin extends into the drilled hole. According to this exemplary embodiment three plate-shaped formations are provided, at least two of the three formations passing materially uniformly into the discharge opening, and the half-moon-shaped stop contour being provided on the third plate-shaped formation arranged on the end face. Alternatively, however, the half-moon-shaped stop contour may also be provided in any of the plate-shape arrangements.

A further embodiment of the invention provides that the rotor part has a cylindrical bearing section for providing a sliding bearing arrangement in the stator part for radial mounting. The bearing section is provided as a cylindrical section on the outside of the rotor part, and may be inserted in a cylindrical inner contour section in the stator part, forming a sliding bearing arrangement. The rotor is therefore mounted axially above the support bearing surface or the end faces of the mixing teeth, and is mounted radially by means of the bearing section.

A cavity is advantageously formed between the sealing lips to catch mixed product escaping through the sealing lips. Furthermore, the stator part has at least one outlet opening on the peripheral side in the cylindrical section of the cavity to prevent the mixed product from escaping on the side of the cylindrical bearing section. Because of the pressure of the mixed product in the mixing chamber, mixed product may still escape through the sealing lips. To prevent mixed product from escaping from the stator part or from the mixing device on the end face, a cavity is provided for receiving escaping mixed product. If the cavity becomes filled with mixed product it may escape through the outlet openings, ultimately to prevent escape of mixed product from the region of the cylindrical bearing section. Two outlet openings are preferably are arranged here, and a single outlet opening may also be provided, preferably in the region of the discharge opening.

In order for the mixing device to be supported on the support plate the stator part of the mixing device carries on its end facing away from the inlet openings an annular support which has fastening openings and is connected releasably and rotatably to the stator part in the manner of bayonet lock. Here rotatability is limited by stops in such a manner that a fit of the inlet opening for binder component A with feeding of binder component A, and at the same time a fit of the two inlet openings for hardener component B with the feeds of hardener component B, are achieved.

The annular support has two opposing slot-shaped openings running in an arc shape in parallel with the peripheral edge of the support, each opening having two guide sections of different widths. The wider guide section is designed for the insertion of an L-shaped guide cam formed on the lower peripheral edge of the stator part, the width of the wider guide section being equal to the length of the free angled member of the guide cam and the narrower guide section having a width which is equal to the thickness of the member of the L-shaped guide cam formed on the lower peripheral edge of the stator part and running in parallel with the longitudinal direction of the mixing device.

The outer wall region of the narrower guide section has a recess whose depth is approximately equal to the thickness of the angled member of the L-shaped guide cam.

Furthermore, the object according to the invention is achieved by a device for producing a ready-to-use filler for the priming of surfaces, for example the surfaces of vehicle bodies, which device is provided with a mixing device, described above, with at least one housing arranged on a support plate for storage container of a binder component, and at least one housing arranged on a support plate for a storage container of a hardener component, and with at least one piston rod assigned to a storage container and preferably connected to a hydraulic cylinder, where a fitting and guide element is provided for the piston rods above the storage container, the fitting and guide element is connected to the support plate by struts, and where the struts re provided on opposite sides.

This provides greater mixing accuracy of the device, since deformations of the device during the mixing operation are minimised, thereby reducing the spring action inside the device down to 2/100 mm.

It is also advantageous for at least one protective cover that can be opened, preferably transparent, to be provided for covering the storage containers, a safety switch being provided in particular preference actively connected to the protective cover and device, which switch switches the device off when the protective cover is open. This increases the reliability of the device.

The invention therefore consists of a device system of two combinable components, namely the support plate with the inlet openings and outlet openings for binder component A and hardener component B, and the mixing device with the inlet openings for the dosed binder component A and dosed hardener component B, the mixing device, in conjunction with its annular support for providing a bayonet-like connection, being designed in a manner essential to the invention so that the mixing device can be connected to the support plate in such a manner that when the mixing device is inserted, its inlet openings for the raw substances are functionally and actively connected to the outlet openings in the support plate, thus creating an airtight connection for preventing lateral escape and undesirable setting of encrusting of components A and B. The concept of the invention is therefore realised by the two system components, namely the actual device, with the specially designed support plate, and the mixing device which, with its inlet openings, can be inserted in the outlet openings of the support plate in a centred manner so that the inlet openings of the mixing device always lie flush with the outlet openings of the support plate so that perfect feeding of both components A and B into the mixing device is guaranteed. Both system components are parts essential to the invention because they interact by means of the bayonet lock.

Further measures improving the invention are indicated in the dependent claims or are represented in the following together with the description of a preferred exemplary embodiment of the invention with reference to the figures.

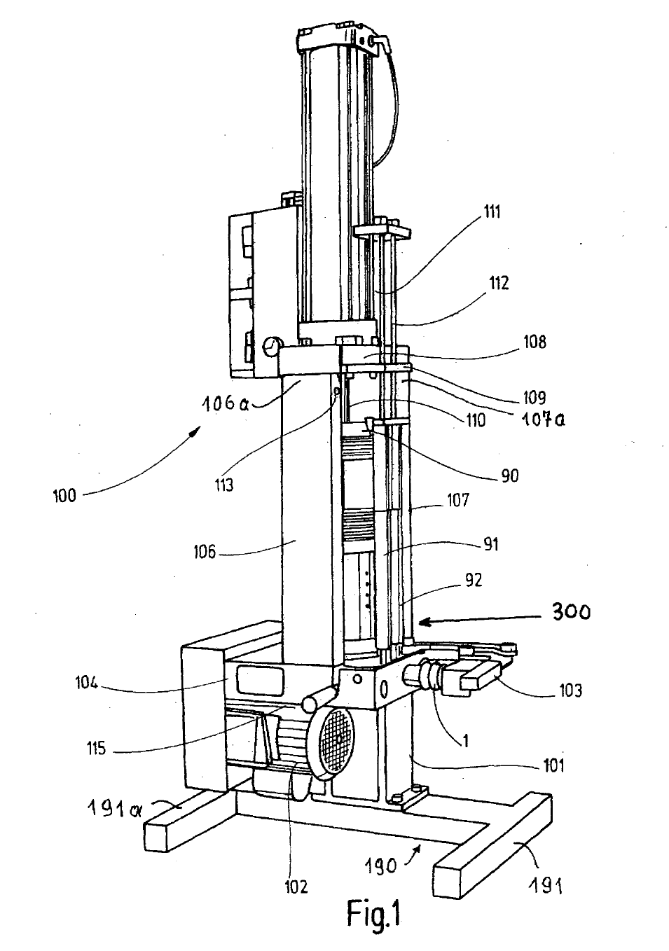

FIG. 1 shows a diagrammatic view of the system of devices for producing aready-to-use filler for the priming of surfaces, e.g. of vehicle bodies, with a device consisting of a stator part and a rotor part, for mixing a plurality of components, and with a support plate for feeding the components to the mixing device,

FIG. 1A shows a diagrammatic view of the system of devices with a support for the piston rods and their drives, consisting of two columns connected by a cross strut, and with an open protective cover,

FIG. 1B shows a diagrammatic view of the system of devices with a support for the piston rods and their drives, consisting of two columns connected by a cross strut, and with the protective cover closed,

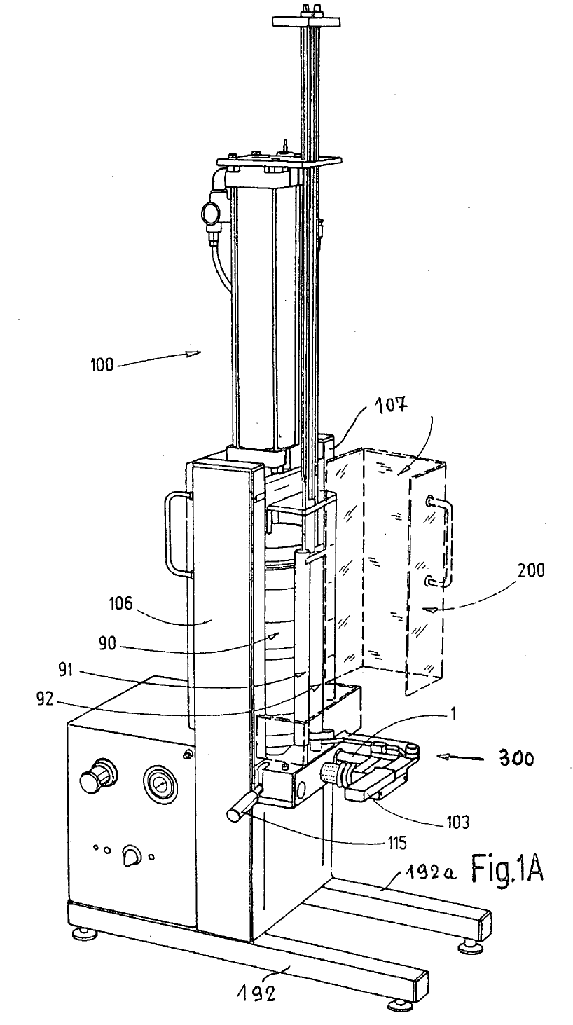

FIG. 2 shows a diagrammatic view of a part of the system of devices for producing a ready-to-use filler with the mixing device inserted in the support plate,

FIG. 2A shows a diagrammatic view of the plate-shaped support plate,

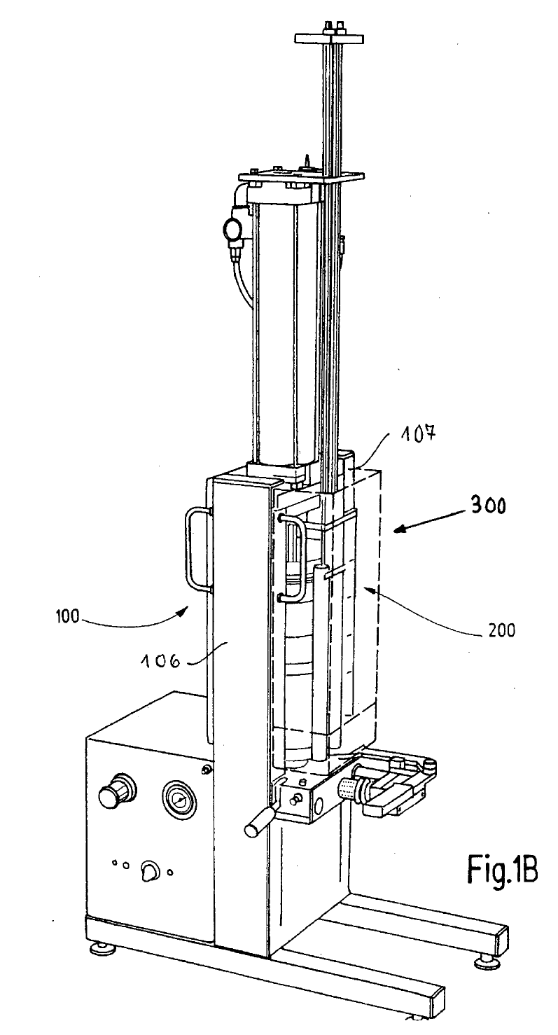

FIG. 3 shows a diagrammatic view of the mixing device consisting of the stator part and the rotor part, with controllable feeds for a binder component and two hardener components from storage containers connected to the mixing chamber, the stator part having at its end facing away from the feeds for the components an annular support connected releasably to the stator part and fixedly to the device,

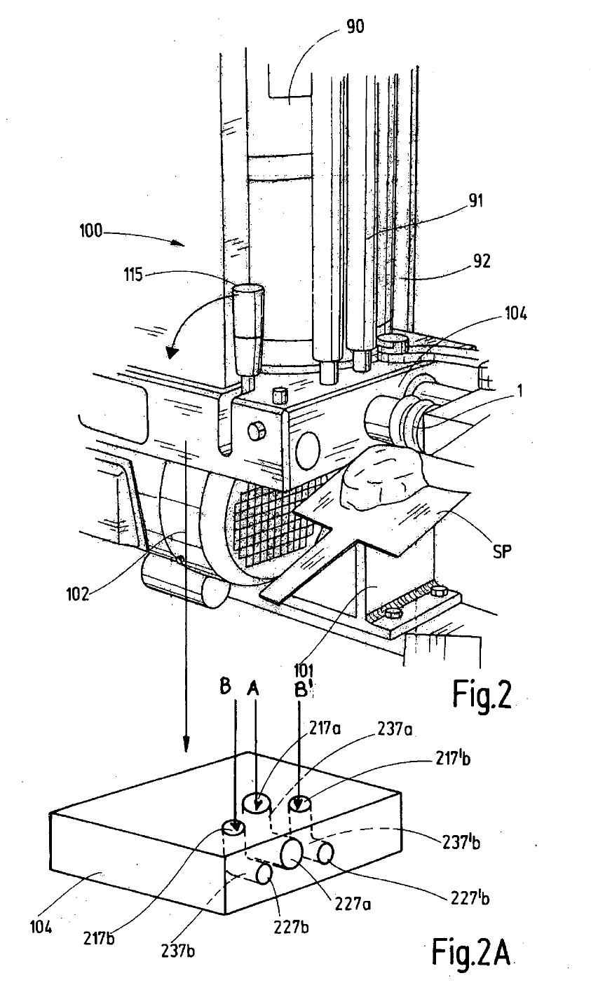

FIG. 4 shows an enlarged view from above of the annular support,

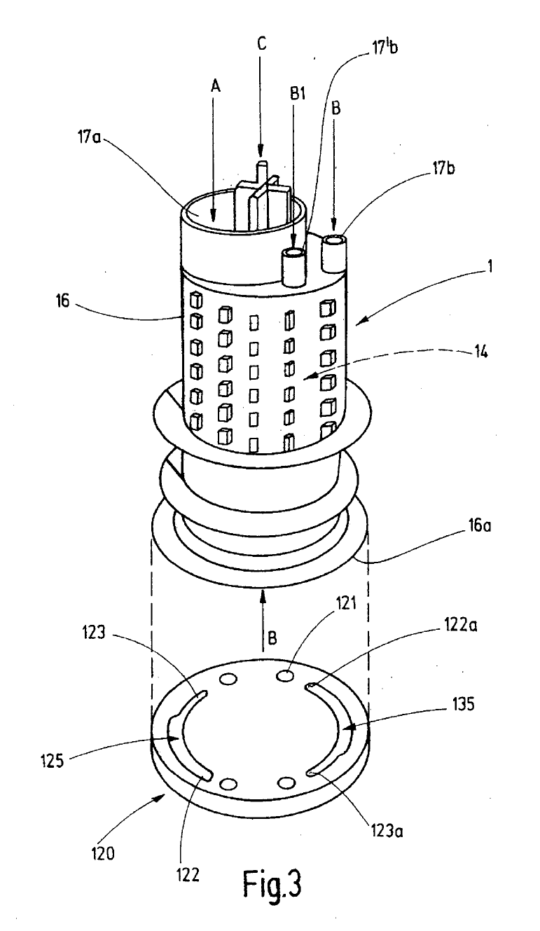

FIG. 5 shows an enlarged view from below of the annular support,

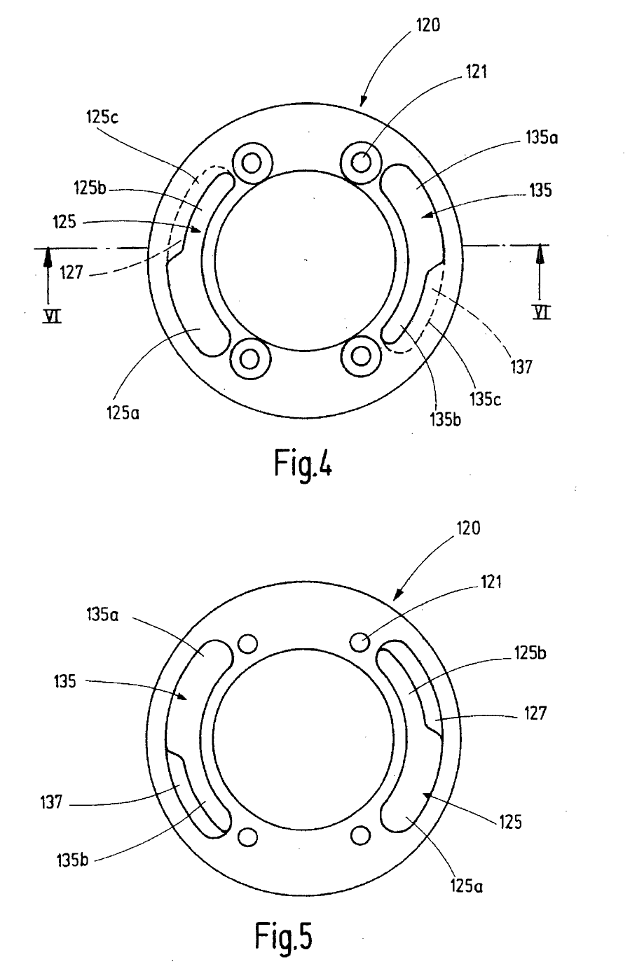

FIG. 6 shows a vertical section alone line V-V in FIG. 4,

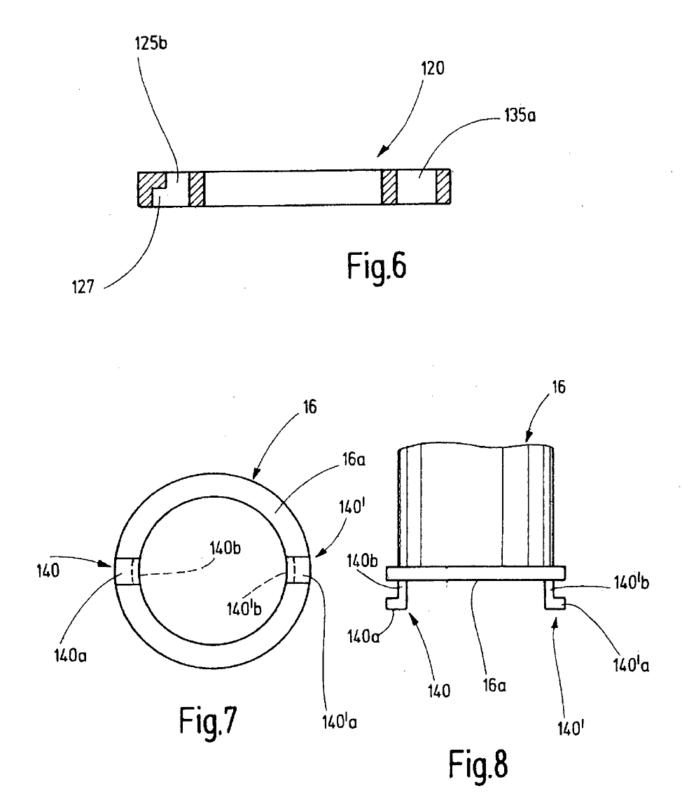

FIG. 7 shows a view from below of the stator part of the mixing device, with the guide cams engaging in the support,

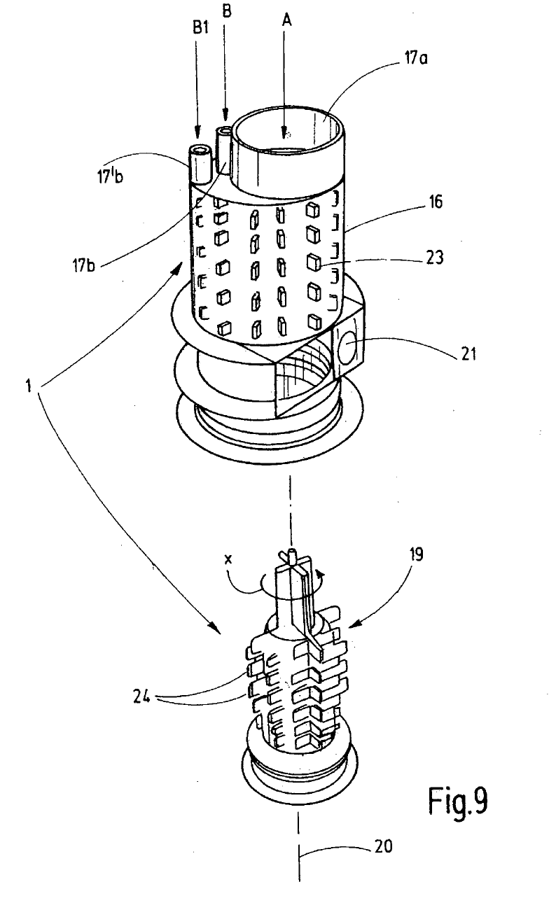

FIG. 8 shows a side view of a part of the stator part with the guide cams formed on it,

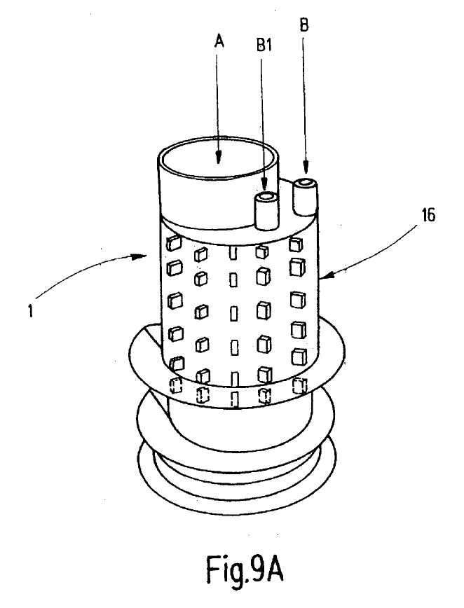

FIG. 9 shows a diagrammatic exploded representation of the mixing device with the stator part and rotor part,

FIG. 9A shows a diagrammatic view of the stator of the mixing devices with the feeds for the binder component and the hardener component,

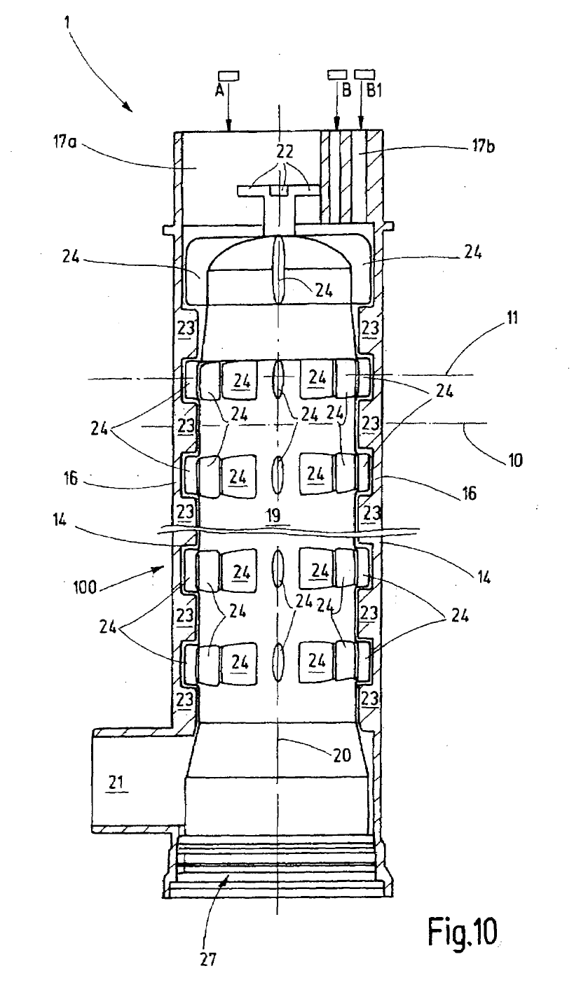

FIG. 10 shows a view of the mixing device in which the rotor part is inserted in the stator part, and in which the stator part is represented in section,

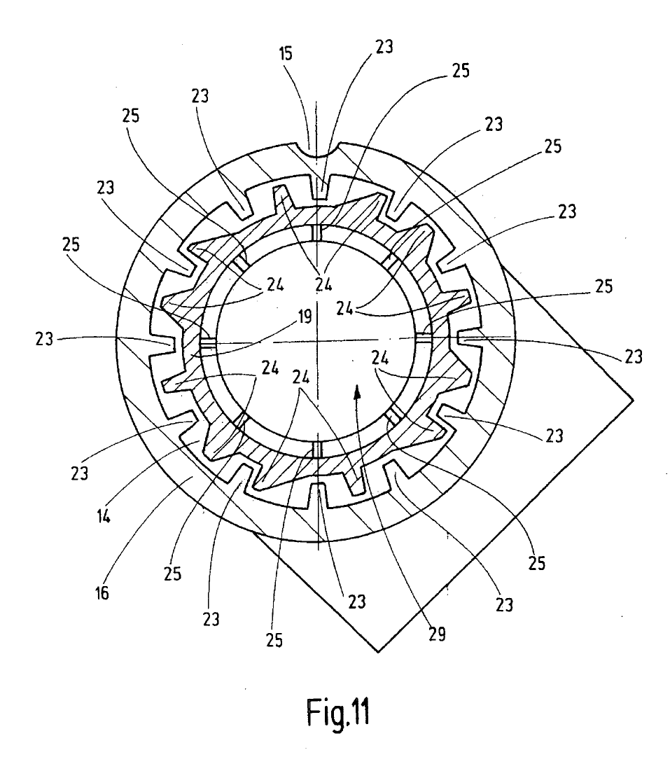

FIG. 11 shows a cross-section through the mixing device with the stator part and rotor part in section,

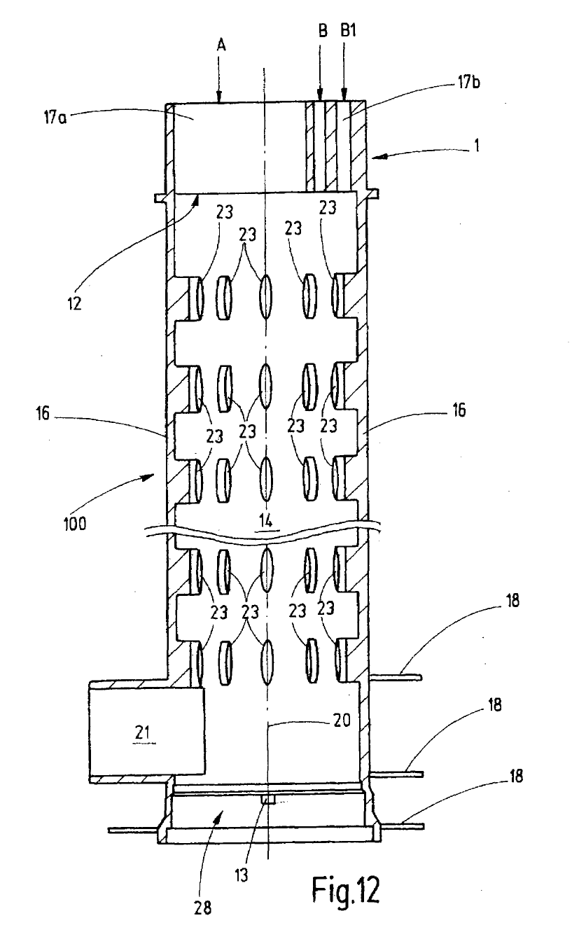

FIG. 12 shows a longitudinal section through the stator part,

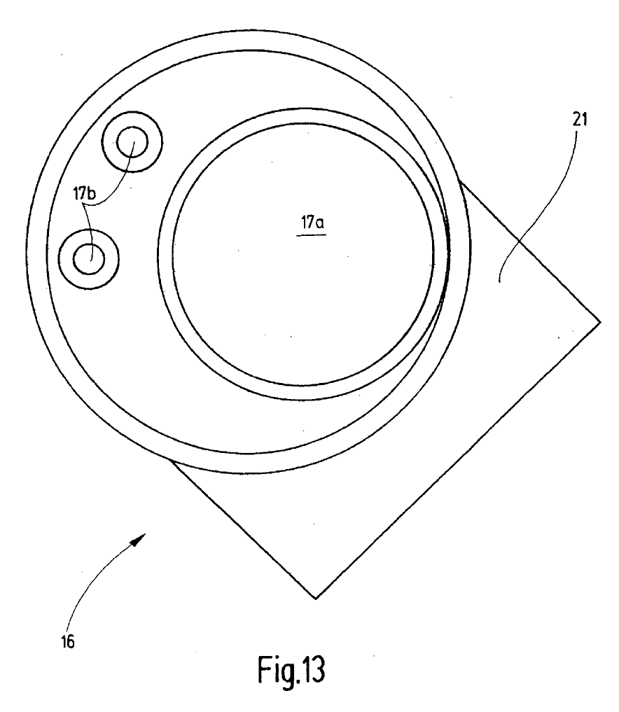

FIG. 13 shows an elevation of the stator part, the elevation being seen on the end face from the direction of the inlet openings,

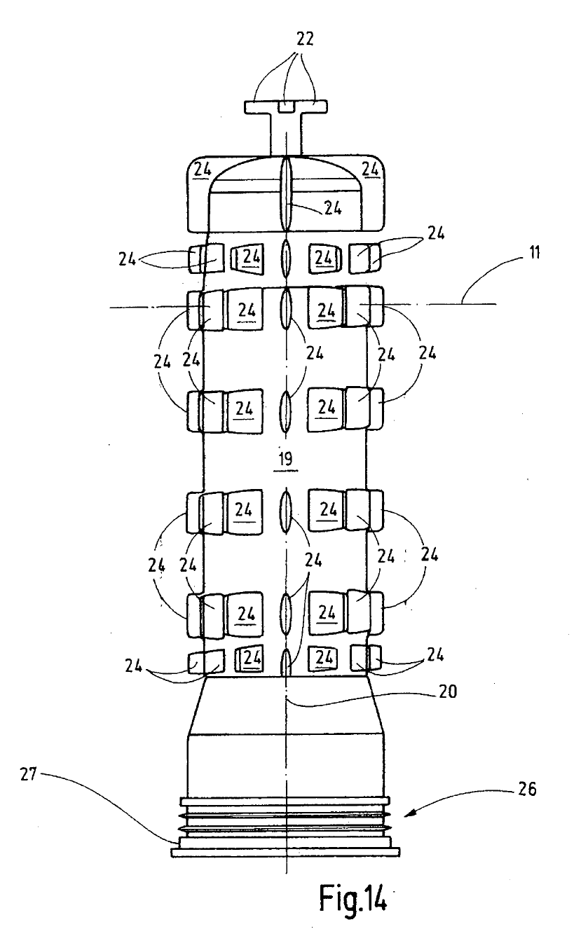

FIG. 14 shows a side view of the rotor part of the mixing device, and

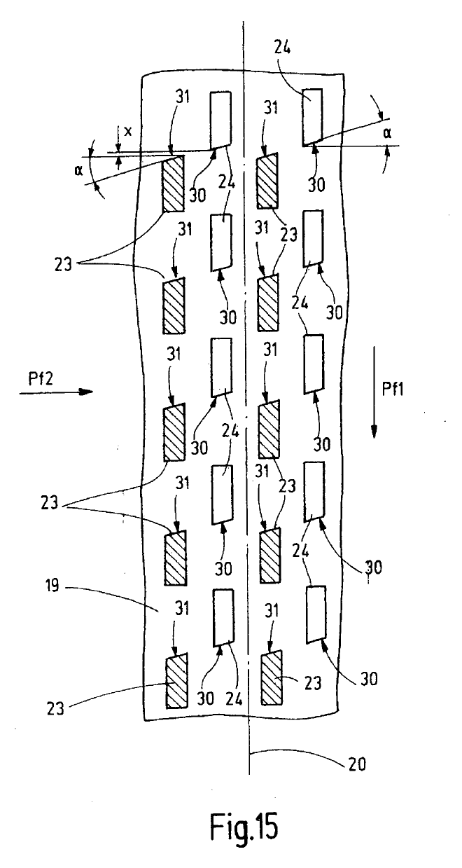

FIG. 15 shows a partial cross-section through the rotor part and the stator part along an annularly rotating mixing zone inside the mixing chamber, the teeth of the stator part being represented by shading and the teeth of the rotor part being unshaded.

The figures only show one exemplary technical design of the present invention.

Device system 100, shown in FIG. 1, for producing a ready-to-use filler for the priming of surfaces, for example those of vehicle bodies, by mixing together a binder component A and at least one hardener component B, comprises as a system component a plate-shaped support plate 104, arranged in a device assembly 300, with an inlet opening 217a for feeding binder component A and, in the exemplary embodiment shown in the drawing, with two inlet openings 217b, 217′b for feeding hardener component B from storage containers 90, 91, 92 arranged on support plate 104, and with a number of outlet openings 227a, 227b, 227′b corresponding to the number of inlet openings 217a, 217b, 217′b, which outlet openings are connected together by means of feed ducts 237a, 237b, 237′b, and comprises a mixing device 1 as a further system component.

Device assembly 300 comprises a foot 101 with a drive motor 102, and a support 103 for a mixing device 1, which consists of a stator part 16 and a rotor part 19, an annular gap being formed between the two cylindrical parts 16 and 19 to form the actual mixing chamber 14. Foot 101 has a support plate 104 for receiving a storage container 90 for binder component A, and in the embodiment shown in FIGS. 1, 2, 10 and 12, two storage containers 91, 92 for a hardener component B, B1. More than two storage containers may also be provided for hardener component B. Storage components 90, 91, 92 are positioned fixedly on support plate 104 so that they are prevented from slipping. The outlet openings of storage containers 90, 91, 92 correspond to inlet openings 217a, 217b, 217′b in support plate 104. These inlet openings 217a, 217b, 217′b are connected by feed ducts 237a, 237b, 237′b in support plate 104 to outlet openings 227a, 227b, 227′b formed in support plate 104, which outlet openings correspond in turn to inlet openings 17a, 17b, 17′b of socket-type lead-ins of mixing device 1 when mixing device 104 is placed on support plate 104 and is locked to it, so that binder component A and hardener component B, B1 pressed out of storage containers 90, 91, 92 are fed via feed ducts 237a, 237b, 237′b and through outlet openings 227a, 227b, 227′b in support plate 104 to inlet openings 17a, 17b, 17′b of mixing device 1 when device assembly 300 is put into operation (FIGS. 2 and 2A). Piston rods retained in storage containers 90, 91, 92 are driven by means of motor operable hydraulic cylinders 110, 111, 112, the free ends of which rods carry plate-shaped pistons so that when hydraulic cylinders 110, 111, 112 are in operation, the piston rods are moved in the longitudinal direction of the piston rods with the pistons lying in the inner spaces of storage containers 90, 91, 92, in order to press the contents of storage containers 90, 91, 92 into mixing device 1. The actuation of motor 102, i.e. the switching on and off, is controlled by actuating lever 115, so that the filler produced can be extracted onto a spatula SP in the desired quantity (FIGS. 1 and 2).

An upper cross strut 108 is provided with a lateral guide 109 for guiding and supporting the piston rods. A front column-like lateral strut 106 and a rear column-like lateral strut 107 are provided on cross strut 108 to guarantee high device stability and bending strength. Hinges or stop elements (not shown) are arranged on the lateral struts to receive a transparent protective cover 200 for covering the region between support plate 104 and upper cross strut 108, in order to guarantee the safety of the operator of device assembly 300. On lateral strut 106 is provided a contact switch 113, as safety switch, which switches off device assembly 300 completely if the cover is not closed (FIGS. 1A and 1B). This protective cover 200 consists of a clear or transparent plastic, preferably Vitak (commercial name).

Device 100 shown in FIG. 1 comprises a mixing device 1 for mixing two components, binder component A being fed via storage container 90 and hardener component B, B1 being fed via two storage containers 91, 92.

Mixing device 1 shown in FIGS. 9, 9A and 10, designed as a disposable system, comprises a stator part 16 and a rotor part 19. Rotor part 19 is inserted in stator part 16 and is mounted rotatably therein. The drive for rotor part 19 is actuated at C (FIG. 9). For feeding the mixed product stator part 16 has inlet openings 17a, 17b and 17′b, binder component A being fed through inlet opening 17a and hardener components B, B1 being fed through the two inlet openings 17b and 17′b. Respective arrows are identified by A, B and B′ for illustrating the feed of the three components. Rotor part 19 is mounted rotatably about a longitudinal axis 20, projections 22 being provided on the end face of rotor part 19, which projections rotate with rotor part 19 and extend into inlet opening 17a. This increases the flowability of the thixotropic binder component A, projections 22 being fitted at different points on the end face of rotor part 19.

Rotor part 19 of the mixing device is driven by a drive device not shown in the drawing and arranged in support plate 14, the drive device being preferably an electromotor drive whose drive shaft is designed at its free end in such a manner that it can be coupled to drive connector 2 of rotor part 19 of the mixing device when mixing device 1 is placed on support plate 104 and is locked to it. The coupling of the drive to drive connector 2 of rotor part 19 is denoted in FIG. 9 by arrow XI.

A further possibility for supporting mixing device 1 on device 1 consists in fitting mixing device 1 to support 103 of foot 101 or on support plate 104 of device 1, in which case this support 103 receives the drive device for rotor part 19.

Mixing device 1 is fastened to and supported on support plate 104 of device 100 by means of an annular support 120. For this purpose stator part 16 carries at its end 16a facing away from inlet openings 17a, 17b, 17′b annular support 120, which has fastening openings 121 and is connected releasably and rotatably to stator part 16 in the manner of a bayonet lock, the rotatability of the mixing device being limited by means of stops 122, 123; 122a, 123a, so that a fit of inlet opening 17a for binder component A with the feed of binder component A, and at the same time a fit of the two inlet openings 17b, 17′b for hardener component B with the feeds for hardener component B are achieved.

This annular support 120 has two slot-shaped openings 125, 135 running in the shape of an arc so that they oppose each other, each opening 125, 135 having two guide sections 125a, 125b, 135a, 135b of different widths, the wider guide section 125a, 135a being designed for the insertion of one of two L-shaped guide cam 140, 140′ formed on the lower peripheral edge 16a of stator part 16, where the width of the wider guide section 125a; 135a is equal to the length of the free angled member 140a, 140′a of guide cam 125, 135, and where the narrower guide section 125b, 135b has a width which is equal to the thickness of member 140b, 140′b of L-shaped guide cam 140, 140′ formed on the lower peripheral edge 16a of stator part 16 and running in parallel with the longitudinal direction of mixing device 1.

Outer wall region 135c, 135c of the narrower guide section 125b, 135b has bridge-like wall sections 125d, 135d, with the formation of tongue-like edge regions 127, 137, so that groove-like recesses are formed whose depth is approximately equal to the thickness of the angled member 140a, 140′a of L-shaped guide cam 140, 140′.

Annular support 120 consists of a plastic or a metal.

Annular support 120 is used as follows: Annular support 120 is fastened to support 103 of foot 101 of device assembly 300, or to support plate 104, in such a manner that slotted openings 125, 135 face mixing device 1 with their wider guide sections 125a, 135a and with their narrower guide sections 125b, 135b (FIG. 4). After the fastening of annular support 120, mixing device is placed on support 120 in such a manner that L-shaped guide cams 140, 140′ of mixing device 1 are guided through the wider guide sections 125a, 135a of slotted openings 125, 135. Mixing device 1 is then rotated about its longitudinal axis until free members 140a, 140′ of L-shaped guide cams 140, 140′ stop against the ends of the narrower guide sections 125b, 135b of slotted openings 125, 135. Here free members 140a, 140′a of L-shaped guide cam 140, 140′ grip from below the tongue-like edge regions 127, 137 of the narrower guide sections 125b, 135b, which run adjacent to the peripheral edge of annular support 120 (FIG. 6). Mixing device 1 is therefore retained in the manner of a bayonet lock on annular support 120 and hence on support 103 of foot 101 of device assembly 300. When mixing device 1 rotates in the opposite direction the bayonet lock is released and mixing device 1 can be removed from device 100 so that a used mixing device 1 can be replaced with a new mixing device. This method of supporting mixing device 1 on device assembly 300 ensures that after mixing device 1 is inserted in annular support 120 the rotatability of mixing device 1 is limited by stops 122, 123, 122a, 123a at the ends of slotted openings 125, 135 of annular support 120, 130 so that a fit of inlet opening 17a for binder component A with the feed for binder component A, and at the same time a fit of the two inlet openings 17b, 17′b for hardener component B with the feeds for hardener components B, B1 are achieved (FIG. 3).

Kinetic energy is introduced into binder component A by projections 22 on the end of rotor part 19 so that its thixotropy is reversibly disturbed. This enables binder component A to be mixed more uniformly with the two hardener components B and B1 when entering a mixing chamber 14 arranged downstream. Mixing chamber 14 is designed in the nature of an annular gap between rotor part 19 and stator part 16. Components A, B and B1 to be mixed together are feed into mixing device 1 in such a manner that they are not combined with each other until they reach the inside of mixing chamber 14. All mixed product residues therefore remain in mixing device 1 after the end of the mixing process and separation of mixing device 1 from a corresponding base station. This is designed as a disposable part which is disposed of after use and replaced by a corresponding new part. Hardener component B and B1 is fed to mixing chamber 14 through the two inlet openings 17b and 17′b, in which chamber the hardener components are mixed with binder component A. Components A, B and B1 are fed in the following sequence: First a small quantity of hardener component B is fed to the mixing chamber. Binder component A and hardener component B1 are then fed simultaneously so that binder component A reaching the mixing chamber meets hardener component B already present in the mixing chamber and is already mixed with it. AS a result of this procedure binder component A flowing into the mixing chamber meets hardener component B already present and is mixed with it so that none of the binder component not having a hardener component is able to escape. Binder component mixed with the hardener component therefore always escapes from the mixing chamber so that the mixture first escaping also contains hardener component and can be processed immediately. Hardener component is then fed to mixing chamber 14 before the binder component flows into the mixing chamber. This hardener component feed is achieved in a controlled manner by providing a corresponding control of dosing devices 90, 91 and 92 for the two hardener components and for the binder component (FIG. 10). Furthermore, the stator of mixing device 1 may also have a feed for the hardener component. In this case a small quantity of hardener component is first fed into mixing chamber 14 by the control system of the dosing device, whereupon the binder component is supplied together with the feeding of further hardener components.

The components to be mixed are fed continuously through mixing chamber 14 to a discharge opening 21 arranged on stator part 16 by means of dosing devices 90, 91, 92 connected upstream, which discharge opening is arranged in the direction of flow behind inlet openings 17a, 17b and 17′b and after mixing chamber 14. A plurality of first mixing teeth 23 is arranged on stator part 16, which teeth extend radially inwards into mixing chamber 14, whereas second mixing teeth 24 are arranged on rotor par 19 and extend radially outwards into mixing chamber 14.

Mixing teeth 23, 24 are therefore moved towards each other by means of a rotary movement of rotor part 19 in stator 16, so that both components A, B and B1 are mixed together. If hardener component B has already been fed in and some of the subsequent binder component A has been mixed with hardener component B, and when the two other components A and B1 are forced into the mixing chamber, further feeding of hardener component B can be set. Binder component A and hardener component B1 fed into mixing chamber 14 are then mixed together. Both these components A and B1 are fed to the mixing chamber in a predetermined ratio until the desired quantity of mixed product is obtained. First mixing teeth 23 are arranged in a first mixing tooth plane 10 and second mixing teeth 24 are arranged in a second mixing tooth plane 11. A total of six first mixing tooth planes 10 and six second mixing tooth planes 11 are provided, arranged alternately in an interlocking manner in the axial direction along longitudinal axis 20. Second mixing teeth 24 rotate radially in the intervening spaces of first mixing teeth 23 due to the rotary movement of rotor part 19, which teeth are formed fixedly on stator part 16. A shear or pitch movement is therefore generated between mixing teeth 23 and 24, so that the mixed product experiences optimum mixing.

Both components A, B and/or B1 are premixed by larger second mixing teeth 24, which are arranged on the front end of rotor part 19, so that these components are premixed by this mixing tooth plane. The larger second mixing teeth 24 arranged on the end face are arranged in fours on the periphery of rotor part 19, and pass into projections 22, also provided in fours. At the open end stator part 16 has a receiving opening in which a cylindrical bearing section 27, which is formed on rotor part 19, enables rotor part 19 to be mounted in stator part 16. This allows radial mounting of rotor part 19 in stator part 16. The diameter fit of the cylindrical bearing section 27 on rotor part 19 is dimensioned in diameter so that a corresponding sliding bearing arrangement is provided.

FIG. 11 shows a cross-section of mixing device 1, where both stator part 16 and rotor part 19 are represented in cross-section. This illustrates, in particular, the arrangement of mixing teeth 23 and 24, second mixing teeth 24 being formed on rotor part 19 so that only a single pitch plane being sufficient for the use of a single stroke injection moulding tool when rotor part 19 is produced by injection moulding. It can also be seen that mixing teeth 23, 24 are formed in a materially uniform manner on stator part 16 and on rotor part 19, so that mixing device 1 consists only of these two components. Rotor part 19 has an inner region which is designed as a hollow recess 29. Stop ribs 25 run radially inwards into recess 29, a total of eight stop ribs 25 being arranged on the periphery. Stator part 16 comprises a half-moon-shaped stop contour 15, which is provided on the outer periphery.

FIG. 12 illustrates a cross-section of stator part 16, which is represented in section along longitudinal axis 20. This therefore shows the arrangements of inlet openings 17a, 17b, 17′b in section, which openings open directly into mixing chamber 14. First mixing teeth 23 are arranged on the inside in the wall of stator part 16, in a total of six planes, a total of twelve first mixing teeth 23 each being provided evenly distributed in one mixing tooth plane. At the end of mixing chamber 14 opposite inlet openings 17a, 17b and 17′b is provided a discharge opening 21, which guides the mixed product radially outwards out of mixing chamber 14 (FIG. 9). Plate-shaped formations 18 are formed on the outer periphery of stator 16, a total of three plate-shaped formations 18 being provided at the height of discharge opening 21 and on the end face of stator part 16. Inlet opening 17a or 17b passes at the height of a support bearing face 12 into mixing chamber 14, support bearing face 12 forming an axial mounting for rotor part 19, not shown here. Stator part 16 is open on the end face at the rear end opposite inlet openings 17a, 17b, 17′b, so that rotor part 19 can be joined into stator part 16 through this opening. In the region of the opening stator part 16 has a cavity 28 designed as a section for receiving the mixed product moving into this region. To allow the mixed product to escape, if necessary, outlet openings 13 are let into the wall, arranged in a maximum of twos on the periphery.

FIG. 13 shows an elevation of stator part 16, which illustrates, in particular, the arrangement of inlet openings 17a, 17b, 17′b. Inlet opening 17a is eccentrically designed and has a circular cross-section. In addition to inlet opening 17a two inlet openings 17b, 17′b are provided to allow redundant feeding of the hardener component into mixing chamber 14. In this case the two inlet openings 17b, 17′b are designed so that they are separated and are fed through feed lines and dosing devices 91, 92, which are also separate. The arrangement of discharge opening 21, which feeds the mixed product laterally out of stator part 16, is also shown.

FIG. 14 shows rotor part 19, in particular second mixing teeth 24, in respect of their distribution on the periphery of rotor part 19. A total of twelve mixing teeth are provided in a mixing tooth plane 11, so that where there are a total of six mixing tooth planes 11 a total of 72 mixing teeth are arranged on rotor part 19. In addition, a further six mixing teeth 24 are provided on the upper section of rotor part 19 for premixing the mixed product. These teeth pass into projections 22, which are also arranged in fours on a kind of extension of rotor part 19.

FIG. 15 illustrates a partial section through mixing device 1 along the annular rotating mixing zone, mixing teeth 23 of stator 16 being represented by shading and mixing teeth 24 of rotor part 19 being represented unshaded. Mixing teeth 23 and 24 of the individual mixing tooth planes are arranged separately from each other so that the teeth have mutual tooth gaps. Between the individual mixing tooth planes mixing teeth 23, 24 have intervening spaces through which run the mixing teeth on the other side opposing the respective intervening space during the rotary movement. Continuous feeding of components A, B into mixing chamber 14 results in a division of the mixed product flow, i.e. one portion of the mixed product always flows past one side of the corresponding tooth 23, 24, and the other portion always flows past the other side of the corresponding tooth 23, 24. Since this division takes place in a plurality of stages corresponding to the number of stages or mixing tooth planes, the mixed product is intensively mixed.

Mixing teeth 23 have end faces 31 which oppose end faces 30 formed on second mixing teeth 24. If mixing teeth 23 and 24 contact each other sliding may take place without material on the mixing teeth being removed. This may happen particularly when rotor part 19 is displaced by an amount x relative to stator part 16, so that mixing teeth 23, 24 hit each other. End faces 30, 31 are bevelled at an angle α, angle α preferably being 15°.

For operation of device 100 the process is such that pistons 110, 111, 112, with the piston plates, are inserted by means of their piston rods 110, 111, 112 by hand into open storage containers 90, 91, 92, and as soon as the piston plates come to rest underneath the opening edges of storage containers 90, 91, 92, motor 102 for the hydraulics is switched on to actuate piston rods 110, 111, 112; only then are the individual mixing processes carried out. This measure prevents injuries which could occur if the finger on the hand of an operator were to be placed in the region of the opening edge, particularly of storage container 90 for binder component A, and were to become trapped by the piston plate moved at relatively high pressure in the direction of the container.

In view of the ability of the door-type cover to be swivelled, the drive devices of the mixer are put into and out of operation in such a manner that when the cover is opened the drive devices are put out of operation. A safety switch, not shown in the drawing, is installed in the cover for this purpose.

To improve the stability of the device it is advantageous for foot 190 of the device to consist of a double-T profile 191, 191a (FIG. 1) or of two beams 192, 192a running parallel with each other, which beams are connected to each other by the device itself (FIG. 1A).

1. A device system (100) for mixing together at least two components, in particular a binder component (A) and a hardener component (B), to form a pasty or fluid mixed product for the production of a ready-to-use filler for the priming of surfaces of vehicle bodies, the system comprising a support plate (104) arranged in a device assembly (300), with an inlet opening (217a) for feeding the binder component (A) from a storage container (90) arranged on the support plate (104), and with at least one further inlet opening (217b, 217′b) for feeding the hardener component (B; B′) from a storage container (91; 92) arranged on the support plate (104), and outlet openings (227a, 227b, 227′b) connected to the inlet openings (217a, 217b, 217′b) by feed ducts (237a, 237b, 237′b) in the support plate (104), and a mixing device (1) connectable functionally to the support plate (104), with a number of inlet openings (17a, 17b, 17′b) of the mixing device (1) corresponding to the outlet openings (227a, 227b, 227′b), wherein the number corresponds to the number of outlet openings (227a, 227b, 227′b), the mixing device having a hollow cylindrical stator part (16) with a discharge opening (21) formed in its wall for the mixed product, and a rotor part (19) arranged concentrically in the stator part and rotatably about a longitudinal axis (20), with a mixing chamber (14) formed by an annular gap between the stator part (16) and the rotor part (19), wherein a plurality of first mixing teeth (23) formed on the stator part (16) extend radially inwards and a plurality of second mixing teeth (24) formed on the rotor part (19) extending radially outwards into the mixing chamber (14) for moving the mixing teeth (23, 24) towards each other by a rotary movement of the rotor part (19) in the stator part (16), thus ensuring mixing of the components (A, B), wherein the stator part (16) has at least one, inlet opening (17b, 17′b) connected to the mixing chamber (14), wherein the first mixing teeth (23) are arranged in at least one first mixing tooth plane (10) and the second mixing teeth (24) are arranged in at least one second mixing tooth plane (11), wherein the mixing tooth planes (10, 11) are offset axially relative to each other in the direction of the longitudinal axis (20) in stages, so that the second mixing teeth (24) of the rotor part (19) rotate radially in the respective intervening spaces of the first mixing teeth (23) of the stator part (16), wherein a plurality of mixing tooth planes (10, 11) are provided on the rotor part (19) and/or on the stator part (16), wherein the number of mixing tooth planes (10, 11) on the rotor part (19) and on the stator part (16) are the same, wherein, for the functional connection between the mixing device (1) and the support plate (104), the stator part (16) carries at its end (16a) facing away from the inlet openings (17a, 17b, 17′b) an annular support (120) which has fastening openings (121) and which is releasably, lockably and rotatably connected to the stator part (16) in the manner of a bayonet lock, and wherein the rotatability is limited by means of stops (122, 123; 122a, 123a) so that a fit of the inlet opening (17a) for the binder component A in the mixing device (1) with the corresponding outlet opening (227a) in the support plate (104), and at the same time a fit of the inlet openings (17b, 17′b) for the hardener component B in the mixing device (1) with the corresponding outlet openings (227b, 227′b) in the support plate (104) are achieved.

2. The device system according to claim 1, wherein the binder component (A) and the hardener component (B) are fed by means of control devices to the mixing chamber (14) in such a manner that the hardener component (B) is fed to the mixing chamber (14) with a short feed distance or a pre-injection relative to the feed of the binder component (A), wherein a quantity of 0.1 gram to 0.5 gram, preferably 0.2 gram, of pasty or fluid hardener component (B), is injected into the mixing chamber (14), before or at the beginning of the continuous mixing process with the rotary movement of the opposing mixing teeth (23, 24).

3. The device system according to claim 1, wherein the stator part (16) carries at its end (16a) facing away from the inlet openings (17a, 17b, 17′b) an annular support (120) which has fastening openings (121) and which is connected releasably and rotatably to the stator part (16) in the manner of a bayonet lock, wherein the rotatability is limited by means of stops (122, 123; 122a, 123a) so that a fit of the inlet opening (17a) for the binder component (A) with the feed for the binder component A, and at the same time a fit of the two inlet openings (17b, 17′b) for the hardener component (B) with the feeds for hardener component B are achieved.

4. The device system according to claim 1, wherein the outer wall region (125c; 135c) of the narrower guide section (125b; 135b) has bridge-like wall sections (125d; 135d) with groove-like recesses, with the formation of tongue-like edge regions (127, 137), the depth of which recesses is approximately equal to the thickness of the angled member (140a; 140′a) of the L-shaped guide cam (140, 140′), wherein the number of L-shaped guide cams may be greater than two L-shaped guide cams.

5. The device system according to claim 1, wherein the annular support (120) consists of a plastic or metal.

6. The device system according to claim 1, wherein the mixing teeth (23, 24) each have end faces (30, 31) which face each other in the axial direction so that they can be positioned between the stator part (16) and the rotor part (19) under an axially acting force.

7. The device system according to claim 6, wherein the end faces (30, 31) are inclined at an angle (α) relative to a plane arranged perpendicularly to the axis of rotation, so that the end faces (30, 31) slide off onto each other during the mixing process without material being removed from the mixing teeth (23, 24) and falling into the mixed product.

8. The device system according to claim 1, wherein the inlet openings (17a, 17b) open directly into the mixing chamber (14), wherein the inlet opening (17b) for feeding the hardener component (B) is provided in duplicate to ensure redundant supply of the mixed product with the hardener component (B).

9. The device system according to claim 1, wherein the rotor part (19) has on its end face projections (22) which project into the inlet opening (17a) for feeding the binder component (A), and rotate with the rotary part (19) so that the thixotropy of the binder component (A) is already reduced in the feed duct of the inlet opening (17a).

10. The device system according to claim 1, wherein the rotor part (19) has a hollow cylindrical recess (29) which is open on its end face and into which a core can be inserted, adapted to its geometry, by means of which core the rotor part (19) can be driven.

11. The device system according to claim 10, wherein the recess (29) has stop ribs (25) running radially inwards from the body of the rotor part (19), which ribs engage in corresponding recesses in the core in order to transmit the drive torque for operating the mixing device (1) from the rotatably driven core to the rotor part (19).

12. The device system according to claim 1, wherein the rotor part (19) has sealing lips (26) to seal the mixing chamber (14) between the rotor part (19) and the stator part (16), and to prevent the mixed product from escaping.

13. The device system according to claim 1, wherein the stator part (16) has at least one plate-shaped formation (18) on the outer periphery, wherein at least one plate-shaped formation (18) comprises a half-moon-shaped stop contour (15) in which a pin element engages when the mixing device (1) is inserted in order to guarantee the radial position of the discharge opening (21) in the stator part (16).

14. The device system according to claim 1, wherein the rotor part (19) has a cylindrical bearing section (27) for providing a siding bearing arrangement in the stator part (16) for radial mounting.

15. The device system according to claim 1, wherein the stator part (16) comprises a support bearing surface (12) against which the rotor part (19) bears and slides on the end face with the mixing teeth (24) formed on it in order to provide an axial sliding bearing arrangement.

16. The device system according to claim 1, wherein a cavity (28) is formed between the sealing lips (26) in order to catch mixed product escaping through the sealing lips (26).

17. The device system according to claim 16, wherein the stator part (16) has at least one outlet opening (13) in the cylindrical section of the cavity (28) on the peripheral side in order to prevent the escape of mixed product on the side of the cylindrical bearing section (27).

18. The device system according to claim 1, wherein at least the stator part (16) is formed from a transparent material, wherein the transparent material is formed from the group of plastics comprising a polycarbonate (PC), a polymethyl metacrylate (PMMA) and/or a styrol/acryl nitrile (SAN) or PP in random quality.

19. The device system according to claim 1, wherein the rotor part (16) is formed from polyoxymethylene (POM), polyacetal and/or polyformaldehyde.

20. The device system according to claim 1, wherein the discharge opening (21) is designed as a radial outlet on a lateral wall section of the stator part (16), wherein the discharge opening is preferably circular in design and/or is arranged pointing laterally on the surface area of the stator part (16) so that it is laterally and radially offset relative to the perpendicular.

21. The device system according to claim 1, wherein the size of the discharge opening is dimensioned so that 100 g of a ready-to-use filler are discharged essentially in 10 s.
